(19) United States
(12) Patent Application Publication
(10) Pub. No.: US 2025/0228720 A1
(43) Pub. Date: Jul. 17, 2025

(54) WHEELCHAIR LEGREST BRACKET AND LEGREST CUSHION EQUIPPED THEREWITH FOR USE

(71) Applicant: Xiamen Yesito Technology Co., Ltd., Xiamen (CN)

(72) Inventor: Dexi XU, Xiamen (CN)

(21) Appl. No.: 19/008,874

(22) Filed: Jan. 3, 2025

(30) Foreign Application Priority Data
Jan. 16, 2024 (CN) 202420106289.4

(51) Int. Cl. A61G 5/12

(52) U.S. Cl. CPC A61G 5/127

(57) ABSTRACT

A wheelchair legrest bracket includes a support rod standing on a front side of a wheelchair. A lower part of the support rod is provided with a detachable part to achieve assembly with and disassembly from the wheelchair, an upper part of the support rod is provided with a footrest part, and the footrest part is located in front of a leg for the leg to stretch forward and rest on. The wheelchair legrest bracket is detachable on the wheelchair and can be used for placing and supporting the leg in a straightened position. The present invention also provides a legrest cushion equipped with the wheelchair legrest bracket for use.

### CROSS-REFERENCE TO RELATED APPLICATIONS

This application claims priority to Chinese Patent Application 202420106289.4, filed on Jan. 16, 2024, which is incorporated herein by reference.

### TECHNICAL FIELD

The present invention pertains to the technical field of medical supplies and specifically relates to a wheelchair legrest bracket and a legrest cushion equipped therewith for use.

### BACKGROUND

The original design intention of a wheelchair is to meet the mobility needs of individuals with limb disabilities and those with mobility difficulties, as well as to help family members move and care for patients. In this way, patients can use wheelchairs for home rehabilitation, outgoing, medical visits, and other activities. A significant proportion of these users are patients with plastered legs.

After plaster casts are applied, these patients always need to keep their legs straight and cannot bend them. This special need has led to the emergence of some innovative wheelchair designs in the market, such as a wheelchair with a rotatable leg frame disclosed in Patent No. CN201320306733.9. This design resolves the problem that patients cannot bend their legs, bringing them greater convenience.

However, it should be noted that despite the innovative designs mentioned above in the market, not all wheelchairs are equipped with a rotatable leg frame. Most wheelchairs are still made based on traditional designs, such as a multifunctional electric leisure wheelchair disclosed in Patent No. CN202120811016.6. Although these wheelchairs have rich functions, they cannot meet the needs of patients who cannot straighten their legs due to the lack of leg support, resulting in limited range of motion, inability to move independently, and relevant inconvenience and discomfort. Therefore, further optimizing wheelchair designs to meet the personalized needs of patients is an important subject in the current market.

### SUMMARY

An objective of the present invention is to provide a wheelchair legrest bracket and a legrest cushion equipped therewith for use. The wheelchair legrest bracket is detachable on the wheelchair and can be used for placing and supporting the leg in a straightened position.

It is simple, comfortable, and convenient for a patient to move.

To achieve the above objective, the present invention provides the following solution: A wheelchair legrest bracket is provided, including a support rod standing on a front side of a wheelchair. A lower part of the support rod is provided with a detachable part to achieve assembly with and disassembly from the wheelchair, an upper part of the support rod is provided with a footrest part, and the footrest part is located in front of a leg for the leg to stretch forward and rest on.

In a preferable solution, the detachable part includes several mounting beams extending outward from a side part of the support rod, and a tail end of the mounting beam is provided with a tube clamp.

In a preferable solution, the tube clamp includes a first clamping arm and a second clamping arm, the first clamping arm is fixed at an end of the mounting beam, two ends of the first clamping arm are hinged ends respectively hinged to one end of the second clamping arm and a fastening screw via pin shafts, the second clamping arm rotates relative to the first clamping arm for clamping, with a tube clamping mouth formed therebetween, the other end of the second clamping arm is provided with a sleeve mouth for accommodating the screw, and a fastening nut is threadedly connected to the screw for tightly clamping the sleeve mouth.

In a preferable solution, an inner surface of the tube clamping mouth is an inclined surface, and a tilt direction and an inclination of the inclined surface are consistent with a tilt direction and an inclination of a footrest tube on the front side of the wheelchair, allowing the inner surface of the tube clamping mouth to match an outer tube surface of the footrest tube.

In a preferable solution, the detachable part of the mounting beam is mounted on and detached from the footrest tube on the front side of the wheelchair, and lengths of the mounting beams decrease sequentially from top to bottom.

In a preferable solution, the support rod is of a separable structure, at least including a main rod and several branch rods that are mounted on and detached from the main rod, the main rod and branch rods are connected in series, a footrest part is disposed on the branch rod, and the detachable part is disposed on the main rod.

In a preferable solution, adjacent two of the rods are arranged in a sleeving manner to control an overall length of the support rod, and a fixing member is provided to relatively fix the two rods together.

In a preferable solution, the footrest part includes a hook provided at the upper part of the support rod and a legrest cushion, the legrest cushion is provided with a hooking part that hooks to the hook, and the legrest cushion is for the leg to stretch forward and rest on.

In a preferable solution, the upper part of the support rod is provided with a barb.

The solution of the present invention further provides a legrest cushion equipped with the above wheelchair legrest bracket for use, including a legrest cushion body and slings disposed on left and right sides of the legrest cushion body. The footrest part is a hook disposed on the upper part of the support rod, the hook is for the slings on the two sides to hook, the legrest cushion body is for the leg to stretch forward and rest on, and a middle part of the sling on each side is provided with an adjustable strap with two ends connected to the sling.

After the use of the foregoing solution, the present invention has the following beneficial effects:
The legrest bracket of the present invention is an auxiliary bracket suitable for being mounted on a wheelchair. The legrest bracket is assembled and disassembled on the front side of the wheelchair, allowing the patient to hang idle items on the bracket. More importantly, the legrest bracket, with the help of a legrest cushion, allows an injured leg to straighten and rest and thus is convenient for patients who cannot bend their legs. After resting the leg, the patient can drive the wheelchair to move around without always relying on an object such as a stool to rest the leg. This broadens the patient's range of movement and lifts the mood. For this, the present invention also provides a legrest cushion equipped therewith for use, which is simple in structure and easy to clean and replace, and has a height adjusting function, allowing the patient to adjust the leg to a comfortable height. Additionally, the legrest bracket can increase sections or be disassembled into multiple sections used as, for example, an intravenous pole or a cane, allowing for more functions and meeting the daily needs of the patient.

### BRIEF DESCRIPTION OF DRAWINGS

FIG. 1 is a schematic structural diagram of a legrest bracket according to an embodiment of the present invention.

FIG. 2 is a schematic structural diagram of the legrest bracket mounted on a wheelchair according to an embodiment of the present invention.

FIG. 3 is a schematic structural diagram of a usage state according to an embodiment of the present invention.

FIG. 4 is a schematic structural diagram of a legrest cushion according to an embodiment of the present invention.

FIG. 5 is a schematic structural diagram of a tube clamp according to an embodiment of the present invention.

### DESCRIPTION OF REFERENCE NUMERALS

1. legrest bracket; 11. support rod; 111. main rod; 112. branch rod; 113. barb; 12. detachable part; 13. mounting beam; 14. tube clamp; 141. first clamping arm; 142. second clamping arm; 143. pin shaft; 144. fastening screw; 145. tube clamping mouth; 1451. inner surface; 146. sleeve mouth; 147. fastening nut; 148. tube joint; 15. footrest part; 151. hook; 152. small hook; 2. legrest cushion; 21. sling; 22. adjustable strap; 3. wheelchair; 31. footrest tube; and 32. chair tube.

### DESCRIPTION OF EMBODIMENTS

The following describes the present invention in detail with reference to the accompanying drawings and specific embodiments.

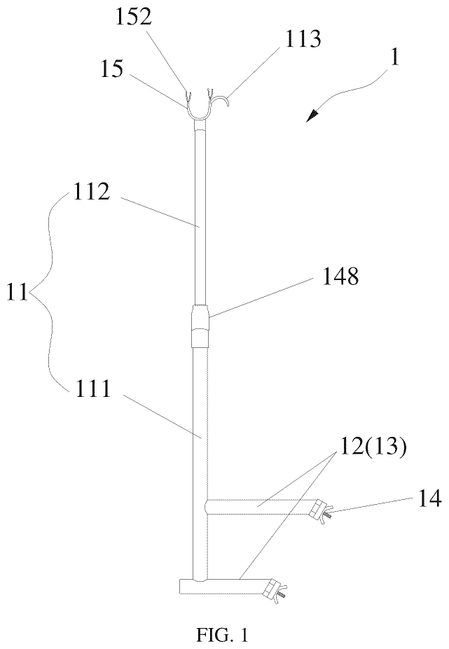

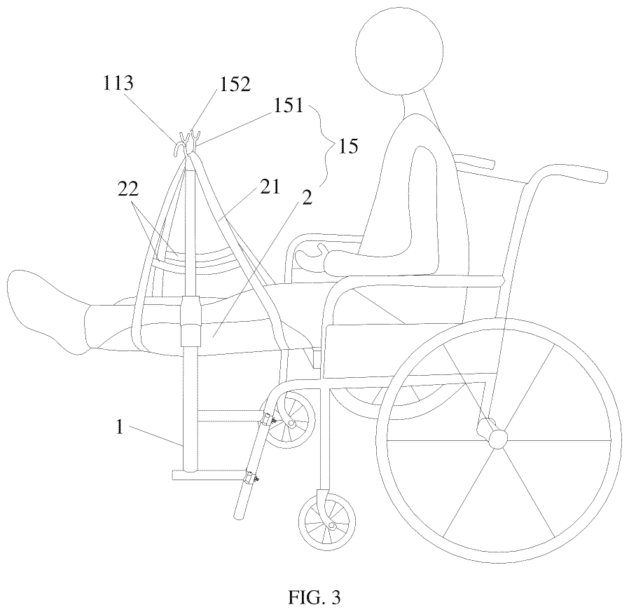

The present invention provides a wheelchair legrest bracket 1 and a legrest cushion 2 equipped therewith for use. The legrest bracket 1 is shown in FIGS. 1 to 3, including a support rod 11 standing on a front side of a wheelchair 3. A lower part of the support rod 11 is provided with a detachable part 12 to achieve assembly with and disassembly from the wheelchair 3, an upper part of the support rod 11 is provided with a footrest part 15, and the footrest part 15 is located in front of a leg for the leg to stretch forward and rest on. At a minimum, the footrest tube 31 and the wheelchair chair tube 32 are located on the front side of the wheelchair 3. As shown in FIG. 3, in this embodiment, the footrest tube 31 is used as an example for description.

Specifically, the detachable part 12 is several mounting beams 13 extending outward from a side portion of the support rod 11. The mounting beams 13 are arranged transversely, and tail ends of the mounting beams 13 are provided with tube clamps 14. The tube clamps 14 tightly lock onto the footrest tube 31, thereby fixedly mounting the support rod 11 on the front side of the wheelchair 3. Unlocking the tube clamp 14 allows the support rod 11 to be removed from the wheelchair 3.

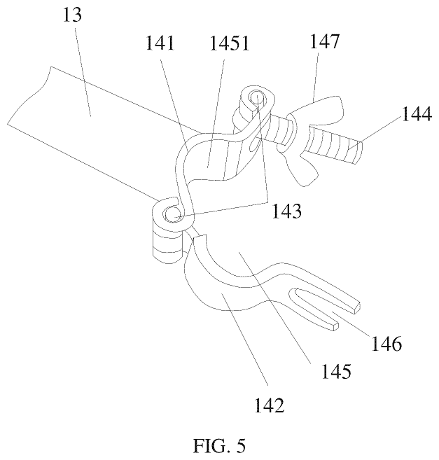

The tube clamp 14 has various structures, and in this embodiment, an economic structure is used, which, as shown in FIG. 5, is specifically as follows: The tube clamp 14 includes a first clamping arm 141 and a second clamping arm 142, the first clamping arm 141 is fixed at an end of the mounting beam 13, two ends of the first clamping arm 141 are hinged ends respectively hinged to one end of the second clamping arm 142 and a fastening screw 144 via pin shafts 143, the second clamping arm 142 rotates relative to the first clamping arm 141 for clamping, with a tube clamping mouth 145 formed therebetween, the other end of the second clamping arm 142 is provided with a sleeve mouth 146 for accommodating the screw, and a fastening nut 147 is threadedly connected to the screw for tightly clamping the sleeve mouth 146. The tube clamp 14 can be assembled and disassembled quickly and is flexible in structure, contributing to a preferred solution.

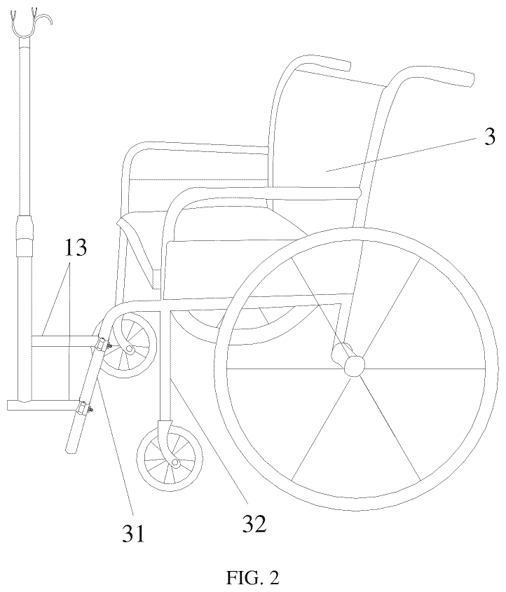

As shown in FIGS. 2 and 3, because the main part of the footrest tube 31 is designed to tilt outward from top to bottom with a certain inclination, to allow the legrest bracket 1 in this case to adapt the inclined footrest tube 31, the lengths of the mounting beams 13 decrease sequentially from top to bottom. This embodiment shows two mounting beams 13, one long in and one short, but the number of mounting beams 13 is not limited in this case.

To further optimize the mounting of the tube clamp 14 and the footrest tube 31, as shown in FIGS. 2 and 5, an inner surface 1451 of the tube clamping mouth 145 is an inclined surface, and a tilt direction and an inclination of the inclined surface are consistent with a tilt direction and an inclination of a footrest tube 31 on the front side of the wheelchair 3, allowing the inner surface 1451 of the tube clamping mouth 145 to match an outer tube surface of the footrest tube 31. This ensures that the support rod 11 still vertically stands on the front side of the wheelchair 3 in a case of the footrest tube 31 being inclined.

This case further involves a separate design; as shown in FIG. 1, the support rod 11 is a separate structure, at least including a main rod 111 and several branch rods 112 mounted on and detached from the main rod 111. FIG. 1 shows only one main rod 111 and one branch rod 112, but there may be multiple branch rods 112. The main rod 111 and the branch rods 112 are connected in series. The branch rod 112 is provided with a footrest part 15, and the main rod 111 is provided with a detachable part 12. The advantages of designing the support rod 11 as a separate structure include but are not limited to the following: 1. The transportation is convenient; 2. the branch rods 112 can be disassembled and used as an auxiliary cane for reaching an object, touching a switch, and the like, providing various functions; and 3. the multiple branch rods 112 can increase the overall height and can be used as an intravenous pole to hang infusion bottles. Other functions are not elaborated herein.

The upper part of the support rod 11 is provided with a barb 113, which helps the patient hook keys and other items and can also be used to tidy up trouser legs.

The separate structure is further optimized. Two adjacent rods (a main rod 111 and a branch rod 112, or a branch rod 112 and a branch rod 112) are arranged in a sleeving manner to control the overall length of the support rod 11, and a fixing member is provided to relatively fix the two rods together. As shown in FIG. 1, the fixing member may specifically be a pipe joint 148 and can be quickly assembled and disassembled.

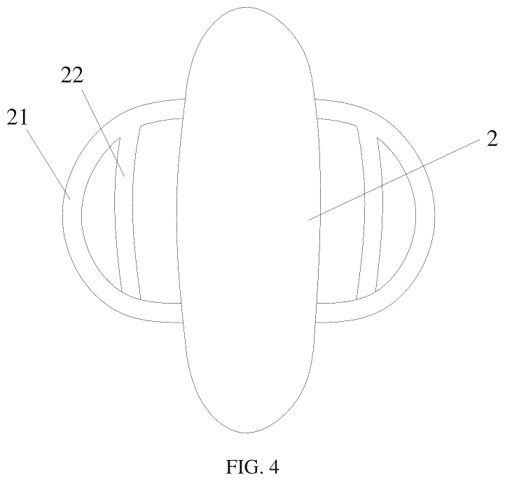

As shown in FIG. 3, the footrest part 15 is a hook 151 provided at the upper part of the support rod 11 and a legrest cushion 2. As shown in FIGS. 3 and 4, the legrest cushion 2 is equipped with the legrest bracket 1 for use. The legrest cushion 2 is provided with a hooking part hooking to the hook 151, and the legrest cushion 2 is for the leg to stretch forward and rest on. In a preferred embodiment, the specific structure of the legrest cushion 2 includes a legrest cushion 2 body and slings 21 (that is, the hooking part) provided on the left and right sides of the legrest cushion 2 body. The hook 151 is for the slings 21 on both sides to hook, forming a space in the middle of the legrest cushion 2 body for the leg to stretch forward and rest on. A middle part of the sling 21 on each side is provided with an adjustable strap 22 with two ends connected to the sling 21. During use, while the adjustable strap 22 is pulled, the sling 21 initially hooking to the hook 151 is removed, and the adjustable strap 22 is used instead to hook to the hook 151. The adjustable strap 22 arranged in the middle can be hooked higher relative to the sling 21, and thus the adjustable strap 22 is used to adjust the height for leg placement, achieving a comfortable effect.

The hook 151 is U-shaped, and both ends of the hook 151 also form two small U-shaped hooks 152. This structure can broaden its function when used as a cane, and for example, can be used as a clothes airing pole.

Because the legrest cushion 2 body is often carried around, it easily gets wet or dirty. Therefore, the legrest cushion 2 body of the present invention can be made of breathable and quick-drying fabric, which is less likely to cause prickly heat in hot summer. When the legrest cushion 2 body gets dirty, it can be washed.

The legrest cushion 2 body has several PP plates (not shown in the figure) arranged side by side therein along the length direction. The PP plates can provide a certain rigidity to the legrest cushion 2 for shaping, preventing the legrest cushion from being too soft and improving comfort during use.

The above descriptions are merely preferred embodiments of the present invention and are not intended to limit the design of this case. Any equivalent changes made based on the key design of this case shall fall within the protection scope of this case.

1. A wheelchair legrest bracket, comprising a support rod standing on a front side of a wheelchair, wherein a lower part of the support rod is provided with a detachable part to achieve assembly with and disassembly from the wheelchair, an upper part of the support rod is provided with a footrest part, and the footrest part is located in front of a leg of a user for the leg to stretch forward and rest on.

2. The wheelchair legrest bracket according to claim 1, wherein the detachable part comprises at least one mounting beams extending outward from a side part of the support rod, and a tail end of each of the at least one mounting beam is provided with a tube clamp.

3. The wheelchair legrest bracket according to claim 2, wherein the tube clamp comprises a first clamping arm and a second clamping arm, the first clamping arm is fixed at an end of a corresponding one of the at least one mounting beam, two ends of the first clamping arm are hinged ends respectively hinged to one end of the second clamping arm and a fastening screw via pin shafts, the second clamping arm rotates relative to the first clamping arm for clamping, with a tube clamping mouth formed therebetween, a second end of the second clamping arm is provided with a sleeve mouth for accommodating the fastening screw, and a fastening nut is threadedly connected to the fastening screw for clamping the sleeve mouth.

4. The wheelchair legrest bracket according to claim 3, wherein an inner surface of the tube clamping mouth is an inclined surface, and a tilt direction and an inclination of the inclined surface are consistent with a tilt direction and an inclination of a footrest tube on the front side of the wheelchair, allowing the inner surface of the tube clamping mouth to match an outer tube surface of the footrest tube.

5. The wheelchair legrest bracket according to claim 2, wherein the detachable part is mounted on and detached from a footrest tube on the front side of the wheelchair, and lengths of the at least one mounting beam decrease sequentially from top to bottom.

6. The wheelchair legrest bracket according to claim 1, wherein the support rod is of a separable structure, comprising a main rod and at least one branch rod that is mounted on and detached from the main rod, the main rod and the at least one branch rod is connected in series, the footrest part is disposed on the at least one branch rod, and the detachable part is disposed on the main rod.

7. The wheelchair legrest bracket according to claim 6, wherein adjacent two rods are arranged in a sleeving manner to control an overall length of the support rod, and a fixing member is provided to relatively fix the adjacent two rods together.

8. The wheelchair legrest bracket according to claim 1, wherein the footrest part comprises a hook provided at the upper part of the support rod and a legrest cushion, the legrest cushion is provided with a hooking part that hooks to the hook, and the legrest cushion is for the leg to stretch forward and rest on.

9. The wheelchair legrest bracket according to claim 1, wherein the upper part of the support rod is provided with a barb.

10. A legrest cushion equipped with the wheelchair legrest bracket according to claim 1, comprising a legrest cushion body and slings disposed on left and right sides of the legrest cushion body, wherein the footrest part is a hook disposed on the upper part of the support rod, the hook is for the slings on the left and right sides to hook, the legrest cushion body is for the leg to stretch forward and rest on, and a middle part of the slings on each side is provided with an adjustable strap with two ends connected to a corresponding one of the slings.
